(19) United States
(12) Patent Application Publication
(10) Pub. No.: US 2008/0047079 A1
(43) Pub. Date: Feb. 28, 2008

(54) Reactive Polyazo Dyes

(75) Inventors: Gunter Goerlitz, Sulzbach/Ts. (DE); Horst Klingenmeier, Morfelden-Walldorf (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 11/576,721

(22) PCT Filed: Oct. 5, 2005
(86) PCT No.: PCT/EP05/55027

§ 371 Date: Jun. 26, 2007

(30) Foreign Application Priority Data
Oct. 8, 2004 (DE) 10 2004 049 092.9

(51) Int. Cl. D06P 3/32; C09B 31/30

(52) U.S. Cl. 8/437; 534/796; 534/806

(57) ABSTRACT

The present invention relates to polyazo dyes of the general formula I 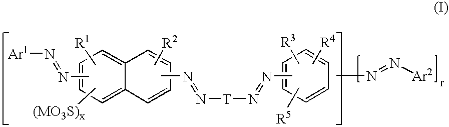
where the variables are each as defined in claim 1, processes for their preparation and their use for dyeing or printing hydroxyl- and/or carboxamido-containing materials.

The present invention relates to reactive dyes.

Reactive dyes have reactive groups via which they can be covalently bonded to fibrous materials having hydroxyl or amino groups. Most available reactive dyes are mainly suitable for dyeing cotton, only a few for other substrates such as nylon, wool or silk. This also holds in particular for the dyeing of leather, for which commercially available reactive dyes have poor affinity with low yields of fixation.

Most dyes currently used to dye leather are anionic dyes, which may be classified as acid dyes, direct dyes or metallized dyes (see for example K. Eitel in H. Herfeld (ed.): Bibliothek des Leders, Vol. 5, Umschau Verlag, Frankfurt 1987. G. Otto: Das Fäjrben des Leders, Roether Verlag, Darmstadt 1962. Colour Index, 3rd ed., Lund and Humphreys, Bradford-London 1971-1976). Since these dyes do not become covalently bonded to the substrate, they may become detached from the leather under extreme conditions.

WO 97/24405, EP 0 716 130 A1 and EP 1 035 171 A1 for example disclose polyazo dyes which contain or may contain reactive groups and which are also contemplated for dyeing leather without, however, solving the problems mentioned.

There is thus a need for dyes for dyeing leather which do not have the disadvantages mentioned and which are notable in particular for good affinity and good fixation.

It has now been found that, surprisingly, certain polyazo reactive dyes do have these properties and solve the technical problem described.

The present invention accordingly provides polyazo dyes of the general formula I 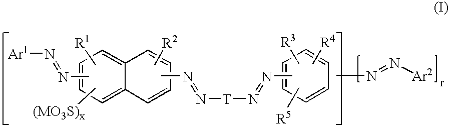
where
Ar¹ and Ar² are independently substituted or unsubstituted aryl subject to the proviso that at least Ar¹ or Ar² bears a fiber-reactive group;
T is a radical of the general formula II 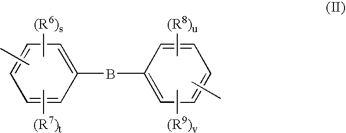
   where B is a bridging element of the formula —NH—, —CO—, —SO₂—, —CH═CH—, —CH₂—CH₂—, —NH—CO—, —NH—SO₂—, —SO₂—NH—SO₂— or a direct bond;
   R⁶, R⁷, R⁸ and R⁹ are independently hydrogen, —SO₃M, hydroxyl, amino, (C₁-C₁₂)-alkylamino with or without substitution in the alkyl group, di-(C₁-C₁₂)-alkylamino with or without substitution in the alkyl groups, substituted or unsubstituted (C₁-C₄)-alkyl, substituted or unsubstituted (C₁-C₄)-alkoxy, halogen or cyano; and
   s, t, u and v are independently 0, 1 or 2;
   or T is a radical of the general formula III 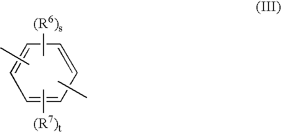
   where R⁶, R⁷, s and t are each as defined above;
R¹ and R² are hydrogen, amino or hydroxyl subject to the proviso that the two radicals cannot both be amino or hydroxyl;
M is hydrogen, an alkali metal or the equivalent of an alkaline earth metal;
x is 0, 1 or 2;
R³ and R⁴ independently have one of the meanings of R⁵ or are
   —COOM, —COOR¹⁰, —CONR¹¹R¹², —SO₂NR¹³R¹⁴ or —CO—R¹⁵;
   and
R⁵ is hydrogen, OR¹⁶ or —NR¹⁷R¹⁸, where
   R¹⁰, R¹¹, R¹², R¹³, R¹⁴, R¹⁵, R¹⁶, R¹⁷ and R¹⁸ are independently hydrogen, unsubstituted (C₁-C₄)-alkyl or (C₁-C₄)-alkyl substituted by hydroxyl, vinyl, phenyl, —CN or —COO(C₁-C₄)-alkyl; and
r is 1 or 2,
except polyazo dyes where r is 2, R⁵ and one of R³ and R⁴ are amino and the other of R³ and R⁴ is —COOM, —COOR¹⁰, —CONR¹¹R¹² or —CO—R¹⁵,
and also their mixtures with each or one another.

Ar¹ and Ar² aryl groups are preferably phenyl and naphthyl. If substituted, they bear 1, 2 or 3 substituents from the group consisting of —SO₃M, hydroxyl, amino, (C₁-C₄)-alkylamino, di-(C₁-C₄)-alkylamino, nitro, (C₁-C₄)-alkyl, (C₁-C₄)-alkoxy, (C₁-C₄)-alkyl-SO₂—, —COOM, —NHCOCH₃ and halogen. The recited (C₁-C₄)-alkyl groups may also be substituted, for example by hydroxyl, vinyl, phenyl, —CN or —COO(C₁-C₄)-alkyl.

Moreover, at least one of Ar¹ and Ar² shall bear a fiber-reactive group. Herein, fiber-reactive groups are groups capable of forming covalent bonds with hydroxyl- and/or carboxamido-containing materials, i.e., say with the hydroxyl groups of cellulose materials or the carboxamide groups of wool, leather or nylon. Such groups will be known to one skilled in the art and are extensively described in the literature.

Preferred fiber-reactive groups are for example groups of the formulae —SO₂CH═CH₂ or —SO₂CH₂CH₂Z, where Z is an alkali-eliminable grouping.

Preferred fiber-reactive groups further include heterocyclic groups of the formulae 1, 2 and 3 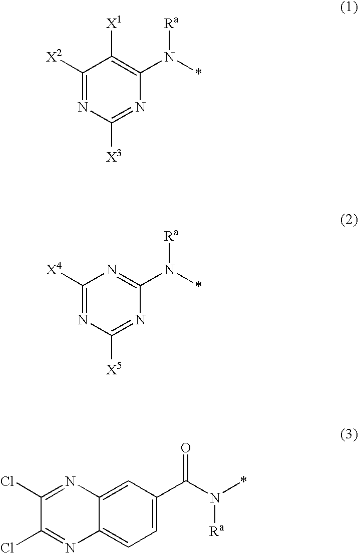
where
* indicates the bond to Ar¹ and Ar²;
R^{a} is hydrogen, phenyl or (C₁-C₄)-alkyl;
X¹ to X³ are independently hydrogen, cyano or halogen with the proviso that at least one of X₂ and X₃ be halogen,
X⁴ is chlorine or fluorine,
X⁵ is a group of the general formula —N(R^{b})—Y—R′,
   where
   R^{b} is hydrogen, phenyl or (C₁-C₄)-alkyl;
   Y is (C₁-C₆)-alkylene with or without interruption by —O— or is a group of the formula 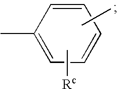
   R^{c} is hydrogen, (C₁-C₄)-alkyl, (C₁-C₄)-alkoxy, sulfo or chlorine; and
   is R is —SO₂CH═CH₂ or —SO₂CH₂CH₂Z, where Z is as defined above; or
is a group of the general formula —N(R^{b})—R″,
   where
   R^{b} is as defined above; and
   R″ is unsubstituted phenyl, phenyl substituted by one, two or three substituents selected from the group consisting of sulfo, (C₁-C₄)-alkyl and (C₁-C₄)-alkoxy, unsubstituted naphthyl, naphthyl substituted by one, two or three substituents selected from the group consisting of sulfo, (C₁-C₄)-alkyl and (C₁-C₄)-alkoxy, or cyano,
   and R^{b} and R″ can also be combined to form a heterocyclic ring, for example piperidino, piperazino or morpholino.

Examples of an alkali-eliminable Z substituent are chlorine, sulfato, thiosulfato, phosphate and (C₂-C₅)-alkanoyloxy, such as acetyloxy and sulfobenzoyloxy. Z is preferably sulfato.

Preferred fiber-reactive groups are for example —SO₂CH═CH₂, —SO₂CH₂CH₂OSO₃H, and 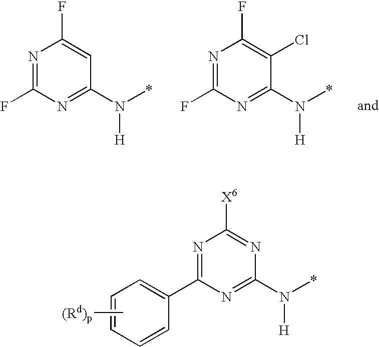
where
* indicates the bond to Ar¹ and Ar²;
X⁶ is fluorine or chlorine;
R^{d} is sulfo, (C₁-C₄)-alkyl, (C₁-C₄)-alkoxy, —SO₂CH═CH₂ or
—SO₂CH₂CH₂OSO₃H; and
p is 0, 1, 2 or 3.

A (C₁-C₄)-alkyl R⁶ to R¹⁸ may be straight-chain or branched and is for example methyl, ethyl, n-propyl, i-propyl, n-butyl, i-butyl, sec-butyl or tert-butyl. The same holds for (C₁-C₄)-alkoxy, (C₁-C₁₂)-alkylamino or di-(C₁-C₁₂)-alkylamino groups.

Halogen is preferably fluorine, chlorine or bromine.

An alkali metal M is preferably lithium, sodium or potassium. An alkaline earth metal equivalent M is preferably one equivalent of calcium.

Preferred polyazo dyes according to the present invention are those of the general formula I where T is a group of the general formula II. It is particularly preferable in this connection when B is —NH—, —NH—CO— or —NH—SO₂—.

Particularly preferred polyazo dyes according to the present invention are characterized by the general formula Ia 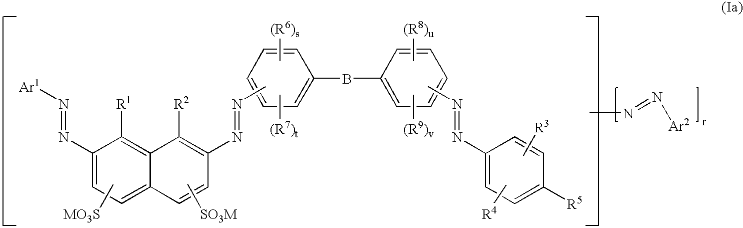
where Ar¹, Ar², R³, R⁴, R⁶, R⁷, R⁸, R⁹, M, r, s, t, u and v are each as defined above;
B is —NH—, —NH—CO— or —NH—SO₂—; and
one of R¹ and R² is hydroxyl and the other amino, and
R⁵ is OR¹⁶ or —NR¹⁷R¹⁸, where R¹⁶, R¹⁷ and R¹⁸ are as defined above.

Very particularly preferred polyazo dyes according to the present invention are characterized by the general formula Ib 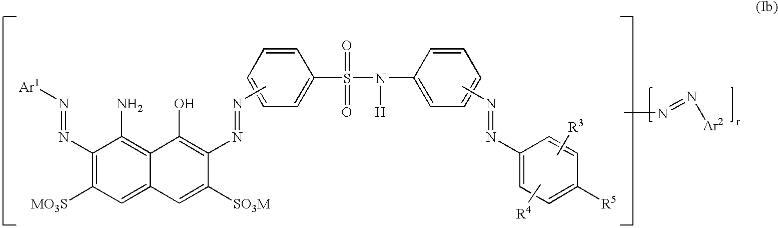
where Ar¹, Ar², R³, R⁴, M and r are each as defined above; and
R⁵ is OR¹⁶ or —NR¹⁷R¹⁸, where R¹⁶, R¹⁷ and R¹⁸ are each as defined above.

The compounds of the general formula I are preparable by constructing them from compounds of the general formulae IV to VIII 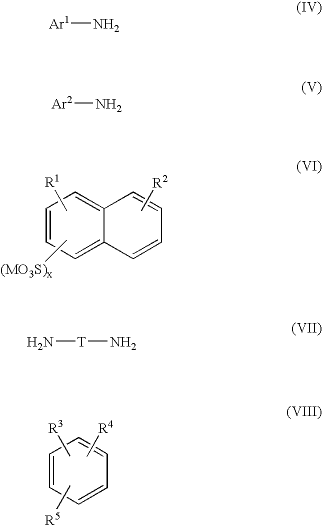
where Ar¹, Ar², R¹ to R⁵, T, M and x are each as defined above, in diazotization and coupling reactions in any order. The diazotization and coupling reactions to be carried out will be known to one skilled in the art and are exhaustively described in the relevant literature.

In one version, for example, one mole equivalent of a compound of the general formula IV is conventionally diazotized with nitrites, for example sodium nitrite, in an acidic medium, for example due to the presence of hydrochloric acid, and the diazotized compound reacted with about 1 mole equivalent of a coupling component of the general formula VI in the acidic medium such that a compound of the general formula IX 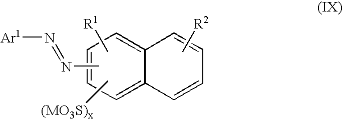
is formed. This compound may subsequently be reacted, in an acidic, neutral or alkaline medium, with a tetrazonium salt formed from the compound of the general formula VII and the resultant intermediate may in turn be reacted, in an acidic, neutral or alkaline medium, with the coupling component of the general formula VIII. The result is a compound of the general formula X 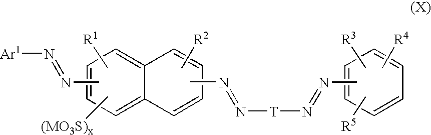
which may either be further reacted without isolation, or alternatively be isolated, for example by salting out with, for example, sodium chloride or precipitation, for example with ethanol, or by evaporation of the reaction solution, if appropriate after a pressure permeation has been carried out.

Finally, 1 to 3 mole equivalents of a compound of the general formula V are conventionally diazotized with nitrites, for example sodium nitrite, in an acidic medium, for example due to the presence of hydrochloric acid, and the diazotized compound reacted with about 1 mole equivalent of the compound of the general formula X in an acidic, neutral or alkaline medium.

The resulting polyazo dye of the general formula I may then either be used, for example for dyeings, without isolation, or be isolated by salting out with, for example, sodium chloride or by precipitation with, for example, ethanol or by evaporating the reaction solution, if appropriate after a pressure permeation has been carried out.

Alternatively, a compound of the general formula VII may be tetrazotized in a conventional manner, for example as described above, and the tetrazotized compound reacted with 1 mole equivalent of a coupling component of the general formula VI for example as described above. The intermediate obtained is then reacted with a diazotized compound of the general formula IV and subsequently with a coupling component of the general formula VIII. The result is a compound of the general formula X which can be converted to the polyazo dye of the general formula I as described above.

When particularly reactive coupling components of the general formula VIII are used and the compounds of the general formulae IV and V are identical, a further version is possible in that about 1 mole equivalent of a compound of the general formula VII is tetrazotized and the tetrazotized compound reacted with 1 mole equivalent of a coupling component of the general formula VI and then with 1 mole equivalent of a coupling component of the general formula VIII. The resulting compound of the general formula XI 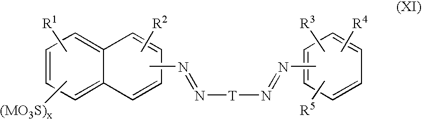
is then further reacted with 2 to 4 mole equivalents of a diazotized compound of the general formula IV or V to form the polyazo dye of the general formula I.

Especially polyazo dyes of the general formula I according to the present invention where r is 1 are obtainable by the following further version whereby 1 to 3 mole equivalents of a diazotized compound of the general formula V are reacted with a coupling component of the general formula VIII to form the compound of the general formula XII

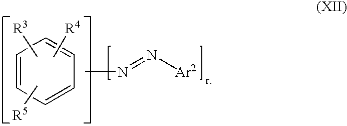

This compound is then reacted with a diazonium salt obtained by reaction of a diazotized compound of the general formula IV with a coupling component of the general formula VI and reaction of the resultant intermediate with a tetrazotized compound of the general formula VII.

The compounds of the general formulae IV and V preferably have the following structures:

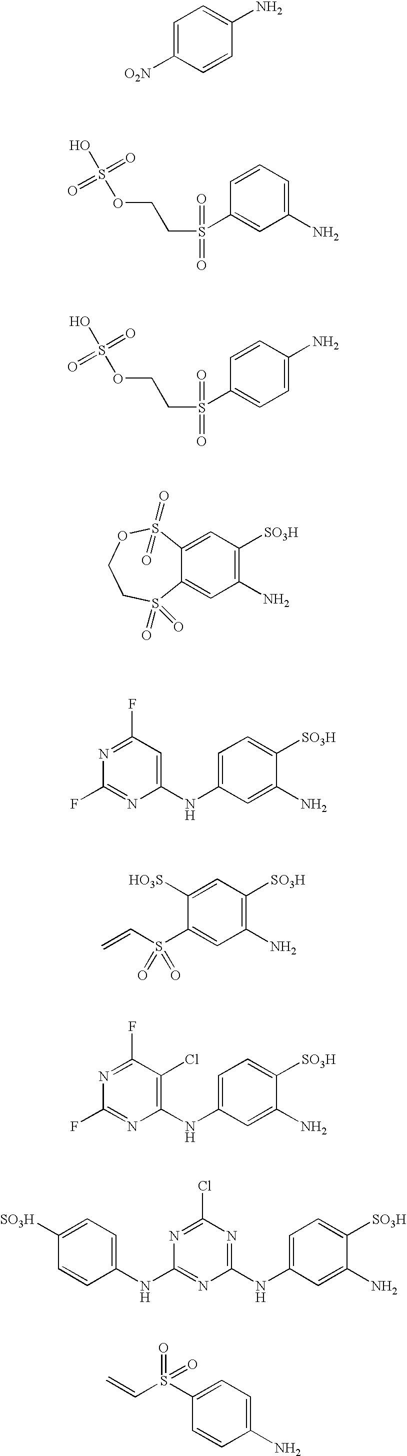

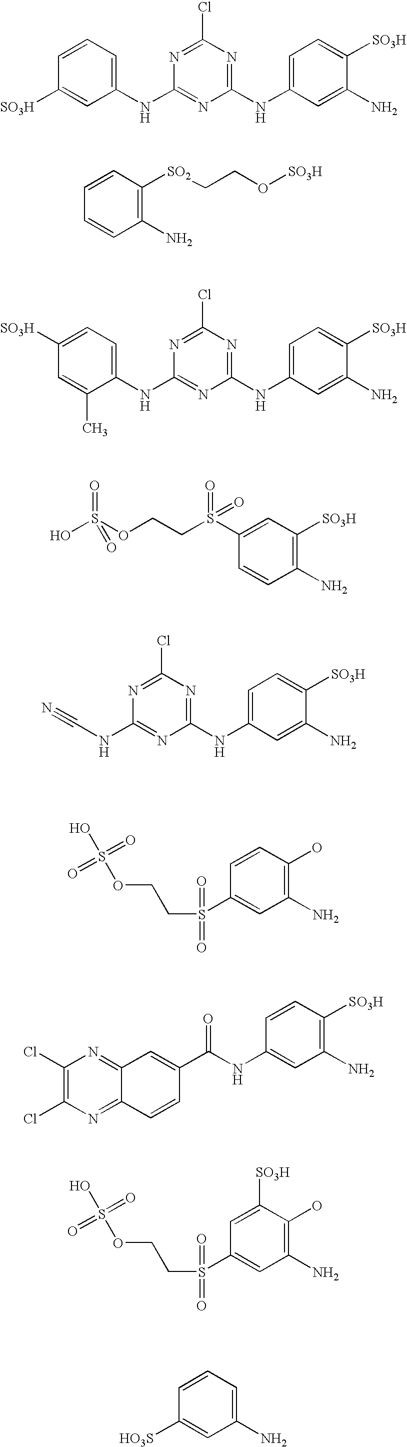

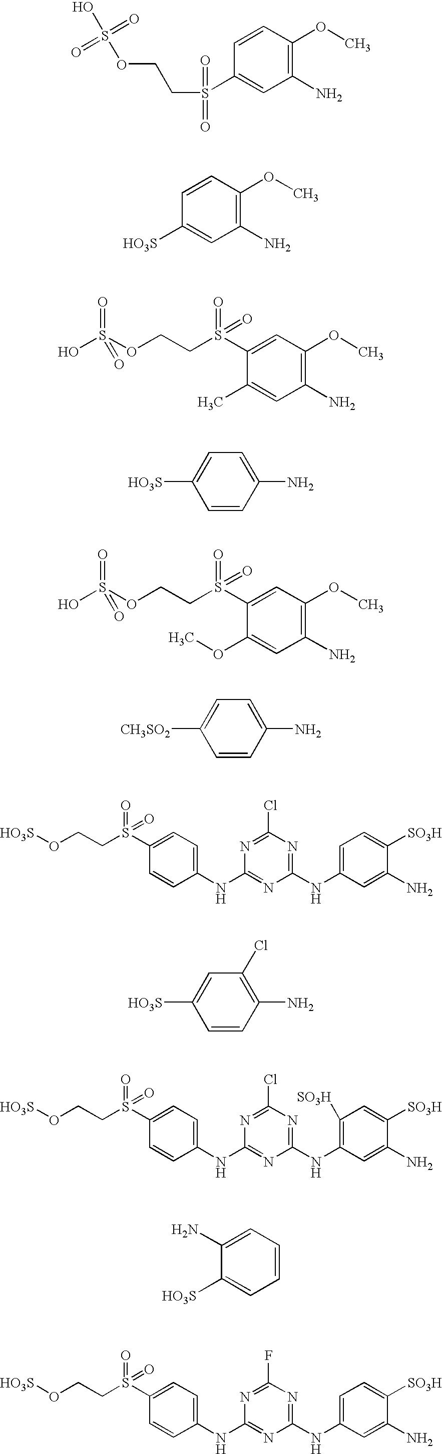

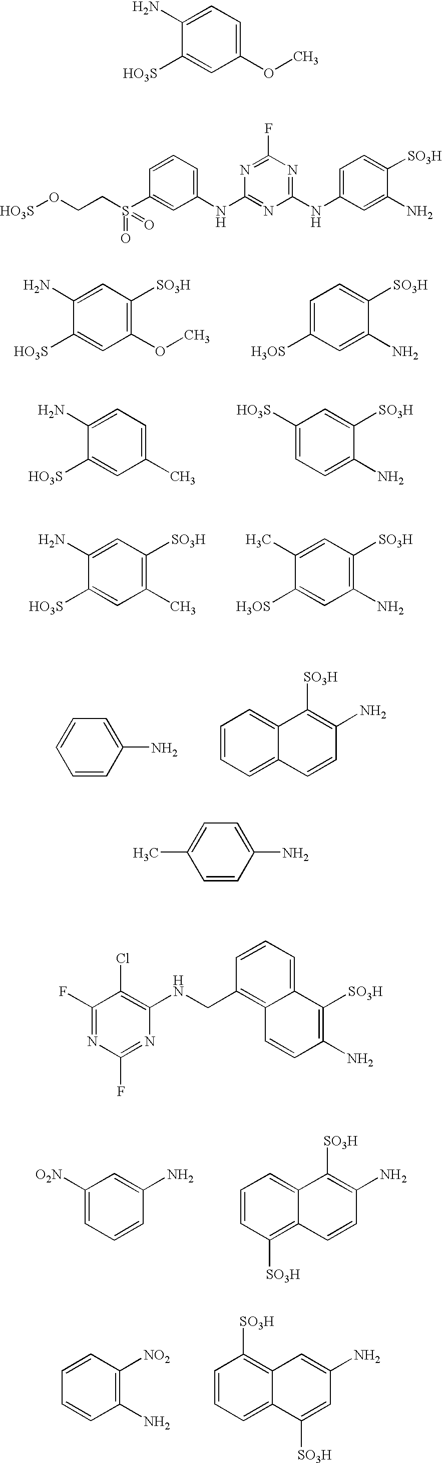

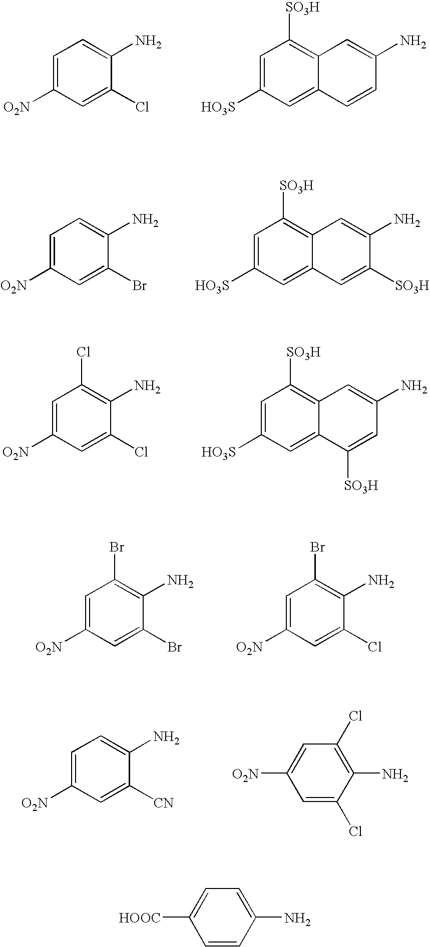

The compounds of the general formulae VI preferably have the following structures:

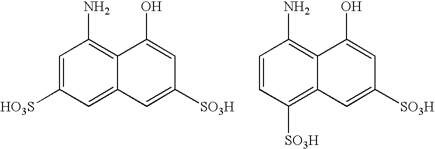

The compounds of the general formulae VII preferably have the following structures:

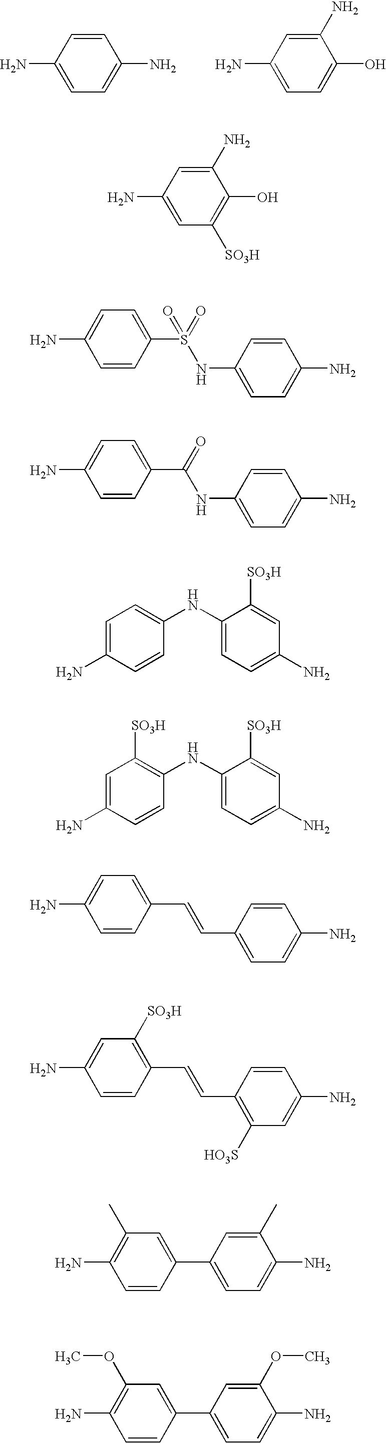

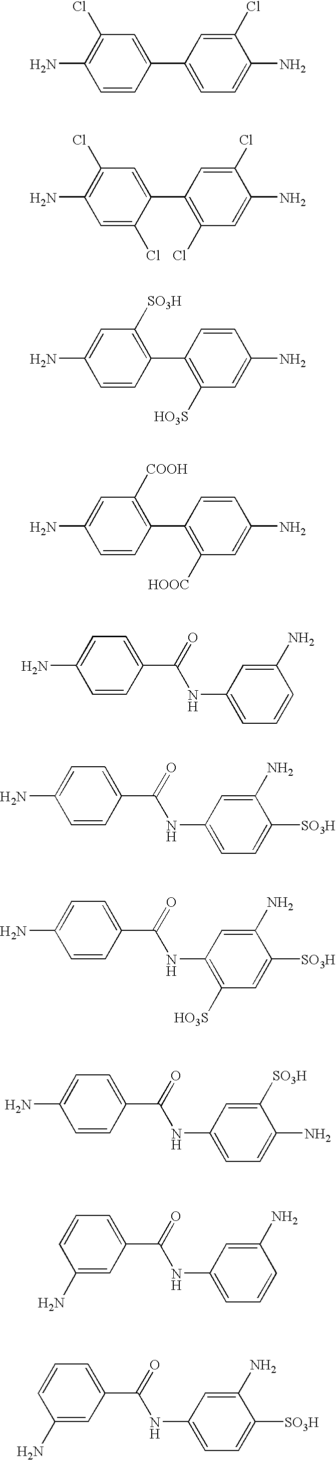

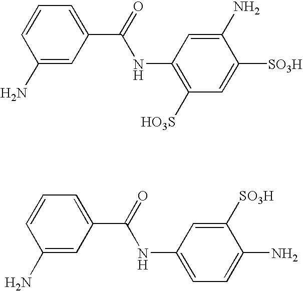

The compounds of the general formulae VIII preferably have the following structures:

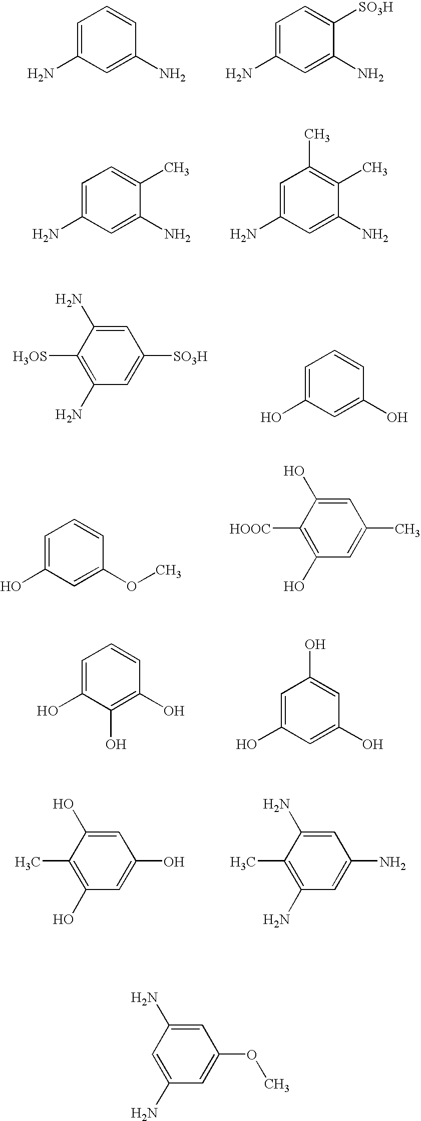

The polyazo dyes according to the present invention possess useful application properties. They are used for dyeing or printing hydroxyl- and/or carboxamido-containing materials, for example in fiber form, in the form of sheetlike structures, such as paper and leather, or of films, of polyamide for example, or in mass, as for example polyamide and polyurethane. Similarly, the as-synthesized solutions of the polyazo dyes according to the present invention may be used for dyeing directly as a liquid preparation, if appropriate after addition of a buffer substance, if appropriate also after concentrating or diluting. Hydroxyl-containing materials are those of natural or synthetic origin, for example cellulosic fiber materials or their regenerative products and polyvinyl alcohols. Cellulosic fiber materials are preferably cotton, but also other vegetable fibers, such as linen, hemp, jute and ramie fibers; regenerated cellulose fibers are for example viscose rayon staple and viscose rayon filament and also chemically modified cellulosic fibers, such as aminated cellulose fibers or fibers as described for example in WO 96/37641 and WO 96/37642 and also in EP-A-0 538 785 and EP-A-0 692 559.

Carboxamido-containing materials are for example synthetic and natural polyamides and polyurethanes, in particular in the form of fibers, for example wool and other animal hairs, silk, leather, nylon-6.6, nylon-6, nylon-11 and nylon-4.

The present invention thus also provides for the use of the polyazo dyes according to the present invention for dyeing or printing these materials or processes for dyeing or printing such materials in conventional procedures which utilize polyazo dyes according to the present invention as a colorant.

Processes for dyeing fiber materials composed of cellulose materials, such as cotton for example, will be known to one skilled in the art and are extensively described in the relevant literature. The same holds for the mass coloration of materials or for dyeing materials in the form of sheetlike structures.

The polyazo dyes of the present invention are preferably used for dyeing wool, nylons and leather.

Wool is dyed in the conventional manner from an acidic medium. For instance, acetic acid and/or ammonium sulfate or acetic acid and ammonium acetate or sodium acetate can be added to the dyebath to obtain the desired pH. To achieve useful levelness on the dyeing, it is advisable to add customary leveling auxiliaries, for example based on a reaction product of cyanuric chloride with three times the molar amount of an aminobenzenesulfonic acid and/or of an aminonaphthalenesulfonic acid or based on a reaction product of for example stearylamine with ethylene oxide. For example, the polyazo dyes according to the present invention are preferably first subjected to an exhaust operation from an acidic dyebath having a pH of about 3.5 to 5.5 under pH control before the pH is then shifted, toward the end of the dyeing time, into the neutral and, if appropriate, weakly alkaline region up to a pH of 8.5 to bring about the full reactive bond between the dyes of the dye mixtures according to the present invention and the fiber to achieve deep shades in particular. At the same time, unfixed dye is detached. The procedure described here is also valid for producing dyeings on fiber materials composed of other natural polyamides or composed of synthetic polyamides. In general, the material to be dyed is introduced to the bath at a temperature of about 40° C., and agitated in the bath for some time, before the dyebath is then adjusted to the desired weakly acidic pH, preferably due to acetic acid, and the actual dyeing is carried out at a temperature between 60 and 98° C. The dyeings can also be carried out at the boil or in sealed dyeing machines at temperatures up to 106° C. Since the water solubility of the polyazo dyes according to the present invention is very good, they can also be used with advantage in customary continuous dyeing processes. The color strength of the dye mixtures according to the present invention is very high.

The process for dyeing leather comprises a plurality of steps known to one skilled in the art which include the pretreatment of the leather, such as retanning for example, the actual dyeing and post-treatment steps such as washing, setting out and staking. Leather is dyed from an acidic medium, for example from formic acid or acetic acid or mixtures thereof and their sodium salts can be added to the dyebath to bring it to the desired pH. Customary leather-processing auxiliaries can be used to achieve levelness and dye penetration. For example, the polyazo dyes of the present invention are dyed up from an acidic dyebath at a pH of about 3.5 to 4.5 at temperatures of 40, 60 or 80° C., the dye becoming fixed to the substrate. Further particulars concerning the dyeing of leather can also be taken for example from K. Eitel in H. Herfeld (ed.), Bibliothek des Leders, Vol. 5, Umschau Verlag, Frankfurt 1987, and also G. Otto, Das Färben des Leders, Roether Verlag, Darmstadt 1962.

In a preferred version of the present invention's process for dyeing leather, the utilized solution of the polyazo dye of the general formula I has a pH of less than 7 and is utilized for dyeing the substrates without the addition of alkali, such as sodium carbonate or sodium hydroxide for example. It is particularly preferable to dye at pH values in the range from 2 to 5, in particular at pH values in the range from 3 to 5.

The examples which follow serve to illustrate the invention. Parts and percentages are by weight, unless otherwise stated. Parts by weight relate to parts by volume like the kilogram relates to the liter.

The compounds described by means of a formula in the examples are shown in the form of the free acid. In general, however, they are prepared and isolated in the form of their alkali metal salts, such as lithium, sodium or potassium salts, and used for dyeing in the form of their salts. Similarly, the starting compounds and components identified in the following examples, in particular table examples, in the form of the free acid can be used in the synthesis as such or in the form of their salts, preferably alkali metal salts.

### EXAMPLE 1

a) 14 parts of 4-nitroaniline are introduced into 25 parts of water with thorough stirring. The suspension obtained is admixed with 60 parts of 20% hydrochloric acid and cooled with 50 parts of ice to 0-5° C. A solution of 7 parts of sodium nitrite in 20 parts of water is then gradually added dropwise until there is a small excess of nitrite. After the conversion of the amine to the corresponding diazo compound is complete, excess nitrite is destroyed by addition of amidosulfonic acid.

b) A neutral solution of 32 parts of 1-amino-8-hydroxy-3,6-disulfonic acid in 100 parts of water is added dropwise, at 25° C. to 30° C. in the course of 90 minutes, to the solution obtained according to a), the pH of the resulting solution being maintained at 0.5-1.5 by addition of 25% aqueous sodium hydroxide solution. On completion of the addition the mixture is stirred until coupling is complete.

c) 26 parts of 4-amino-N-(4-aminophenyl)benzenesulfonamide are introduced into 87 parts of 20% hydrochloric acid with stirring. 80 parts of ice are added for cooling. A solution of 14 parts of sodium nitrite in 20 parts of water is then gradually added dropwise until there is a small excess of nitrite. After the conversion of the diamine to the corresponding tetrazo compound is complete, excess nitrite is destroyed by addition of amidosulfonic acid.

d) The solution prepared according to b) is admixed with 100 parts of ice, followed by the reaction mixture prepared according to c), which is added over 60 minutes during which the pH of the solution is maintained at 0.5-1.5 by addition of 25% aqueous sodium hydroxide solution. On completion of the addition the pH is adjusted to 6-7 over 60 minutes before stirring at this pH for 10 minutes. Thereafter, solid sodium carbonate is added to the reaction mixture until a pH of 7-8 is reached. Stirring is continued until coupling is complete.

e) 11 parts of m-phenylenediamine are added to the reaction mixture obtained according to d). The pH of the reaction mixture is maintained at 8-8.5 by addition of 25% aqueous sodium hydroxide solution and the reaction mixture is stirred until coupling is complete. After coupling has ended, the reaction mixture is heated to 50° C. and adjusted to pH 5-6. The dye obtained is precipitated in a conventional manner by addition of sodium chloride. The suspension obtained is filtered off with suction and the filter cake is dried at 50° C. to leave a compound which in the form of the free acid conforms to the formula

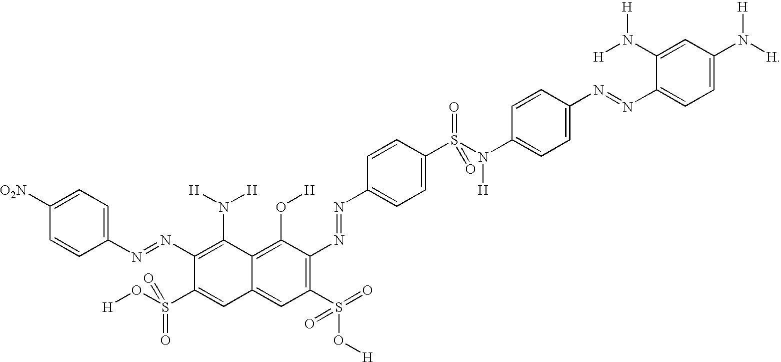

f) 28 parts of 2-(4-aminobenzenesulfonyl)ethyl hydrogensulfate are introduced into 150 parts of water with thorough stirring. The suspension obtained is admixed with 17 parts of 31% hydrochloric acid and cooled with ice to 0-5° C. A solution of 7 parts of sodium nitrite in 20 parts of water is then gradually added dropwise until there is a small excess of nitrite. After the conversion of the amine to the corresponding diazo compound is complete, excess nitrite is destroyed by addition of amidosulfonic acid.

g) Half the product obtained according to e) is stirred up in 250 parts of water and the pH of the solution is maintained at 6-7 by addition of 10% by weight aqueous lithium hydroxide solution. This is followed by heating to 50° C., stirring at 50° C. for 120 minutes and cooling down to 30° C. The diazonium salt suspension prepared according to f) is then gradually added dropwise while the pH is maintained at 6.5-7.0 by addition of 10% by weight aqueous lithium hydroxide solution. Completion of the addition is followed by stirring for 60 minutes, heating to 50° C. and stirring until the coupling reaction has ended. After the coupling has ended, the reaction mixture is cooled down to room temperature and adjusted to pH 4-5. The dye obtained is precipitated in a conventional manner by addition of sodium chloride. The suspension obtained is filtered off with suction and the filter cake is dried at 50° C. to obtain a mixture which in the form of the free acid conforms to the formula 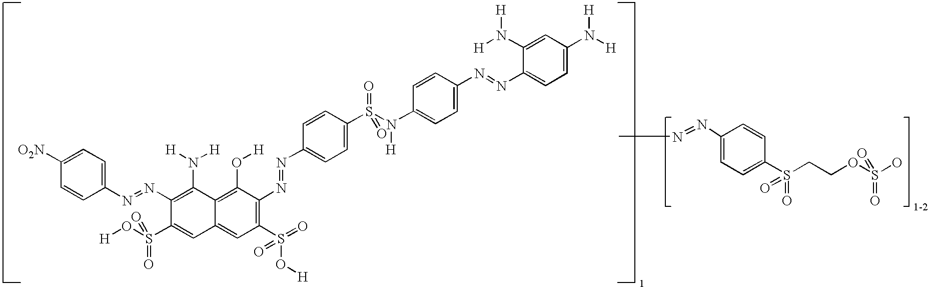
in which the dye of the formula 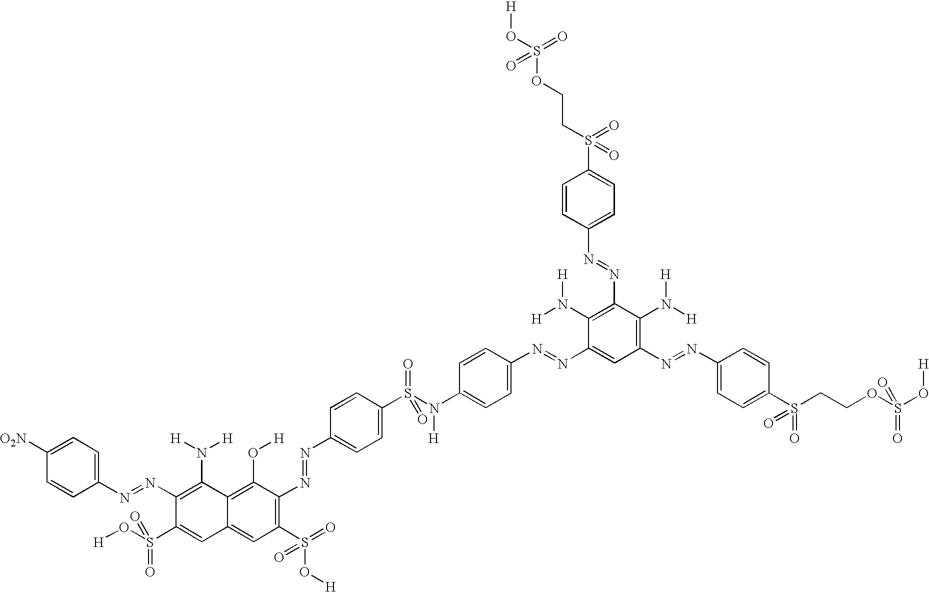
is present as main component. The product is obtained as a dark powder which dyes wool and nylon in olive green, and cattle-hide side leather in black, shades having good all-round fastnesses. The dye goes very well onto the substrate and has good detachment fastnesses, for example solvent fastnesses.

### EXAMPLE 2

a) 32 parts of 1-amino-8-hydroxy-3,6-disulfonic acid are introduced into the solution obtained according to Example 1f, the pH of the solution being maintained at 1-2 by addition of 15% sodium carbonate solution. The solution is stirred for 360 minutes, during which time it is gradually heated to 35° C. Thereafter, the solution is stirred until coupling is complete, cooled down to 25° C. and adjusted to pH 4.5-5.5 by addition of 15% sodium carbonate solution.

b) 100 parts of ice are added to the solution prepared according to a), the pH is adjusted to 0.5-1.0 by addition of 20% hydrochloric acid, and the reaction mixture prepared according to Example 1c is added over 60 minutes. This is followed by raising of the pH to 6-7 by addition of 25% aqueous sodium hydroxide solution over 60 minutes and stirring for 10 minutes. Thereafter, sufficient sodium carbonate is added for a pH of 7.5-8. The temperature of the reaction mixture should then be 20-25° C. The mixture is stirred until coupling is complete.

c) 11 parts of m-phenylenediamine are added to a reaction mixture obtained according to b). The pH of the reaction mixture is maintained at 8-8.5 by addition of 25% aqueous sodium hydroxide solution before stirring until coupling is complete. After coupling has ended, the pH is adjusted to 10-11 by addition of 25% by weight aqueous sodium hydroxide solution, which is followed by stirring at 20-25° C. for 60 minutes and adjustment to pH 9-10 by addition of 20% hydrochloric acid. The dye obtained is precipitated in a conventional manner by addition of sodium chloride. The suspension obtained is filtered off with suction. The filter cake obtained is suspended in 450 parts of water and a pH of 6-7 is set by addition of 20% hydrochloric acid. The suspension obtained is filtered off with suction and the filter cake is dried at 50° C. to leave a compound which in the form of the free acid conforms to the formula

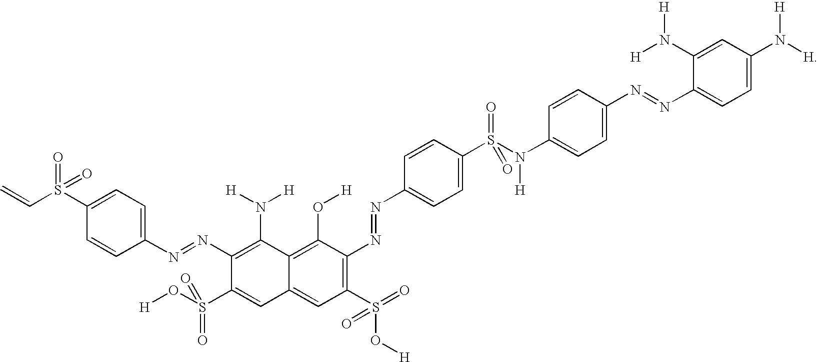

d) One tenth of the product obtained according to c) is stirred up in 150 parts of water and the mixture is adjusted to pH 6-7. The mixture is heated to 50° C., stirred at 50° C. for 60 minutes and cooled down to 35° C. The tenth part of a diazonium salt suspension prepared according to Example 1f is then slowly added dropwise, the pH being maintained at 6-7 by addition of 10% aqueous lithium hydroxide solution. On completion of the addition the mixture is stirred for 60 minutes, heated to 50° C. and stirred until the coupling reaction has ended. After the coupling has ended, the reaction mixture is cooled down to room temperature. The dye obtained is precipitated in a conventional manner by addition of sodium chloride. The suspension obtained is filtered off with suction and the filter cake is dried at 50° C. to leave a mixture which in the form of the free acid conforms to the formula 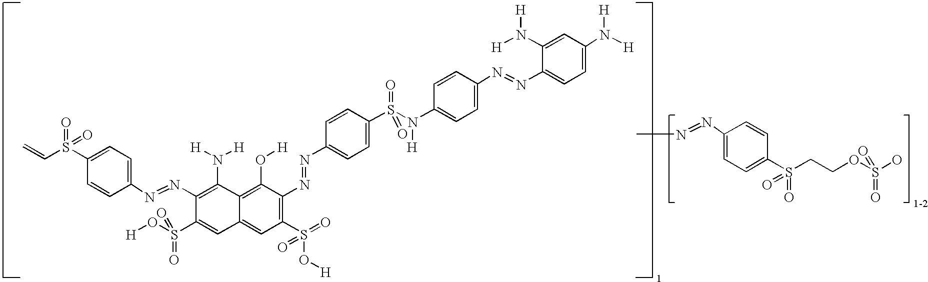
in which the dyes of the formulae 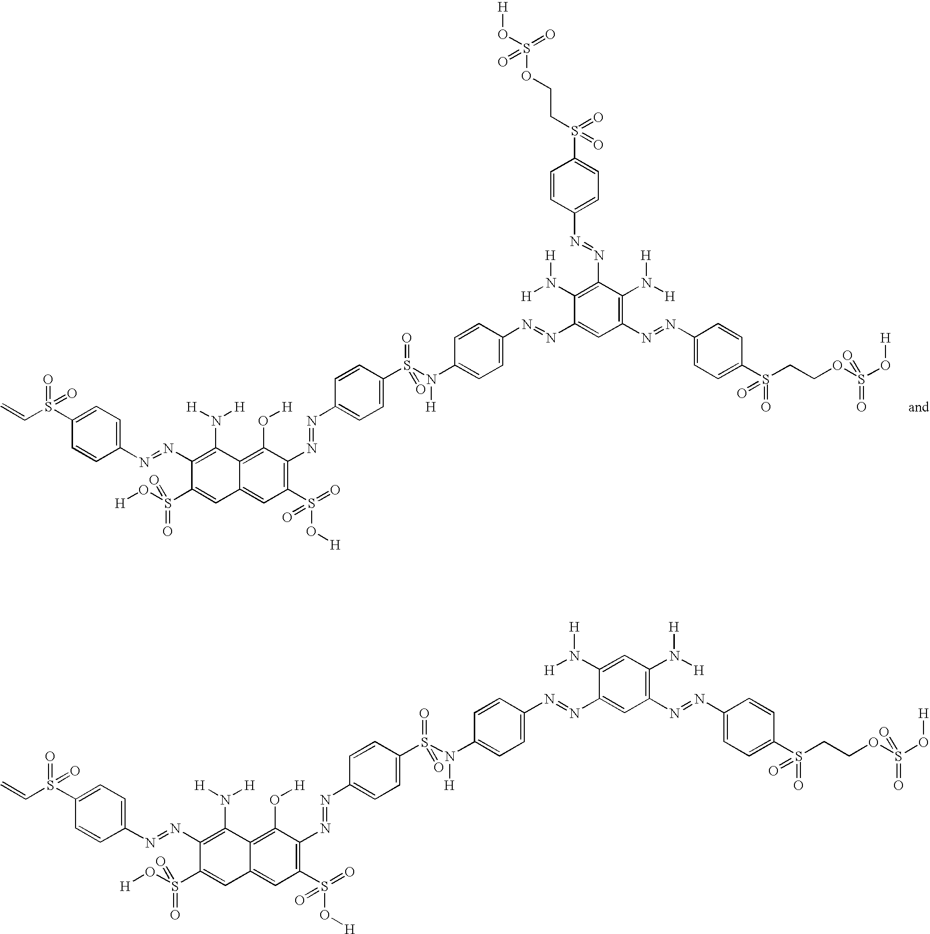
are present as components. The product is obtained as a dark powder which dyes cattle-hide side leather in black shades having good all-round fastnesses.

### EXAMPLE 3

The product obtained according to Example 1e is reacted in the manner described in Example 2d, with a diazonium salt obtained from the compound of the formula 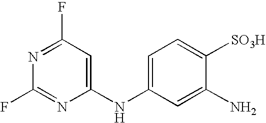
by the method described in Example 1a. The dye obtained is precipitated in a conventional manner by addition of sodium chloride. The suspension obtained is filtered off with suction and the filter cake is dried at 50° C. to leave a mixture which in the form of the free acid conforms to the formula 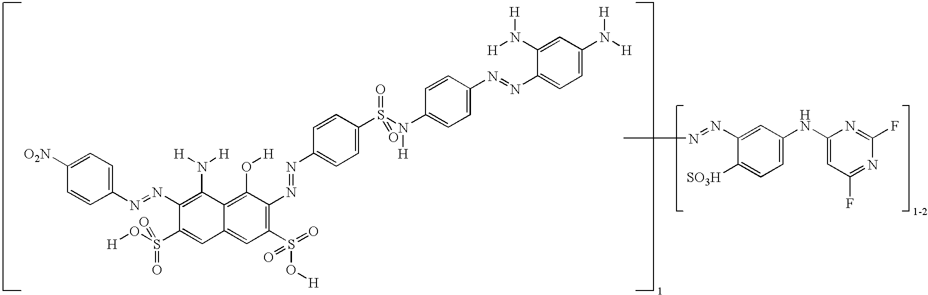
in which the dyes of the formulae 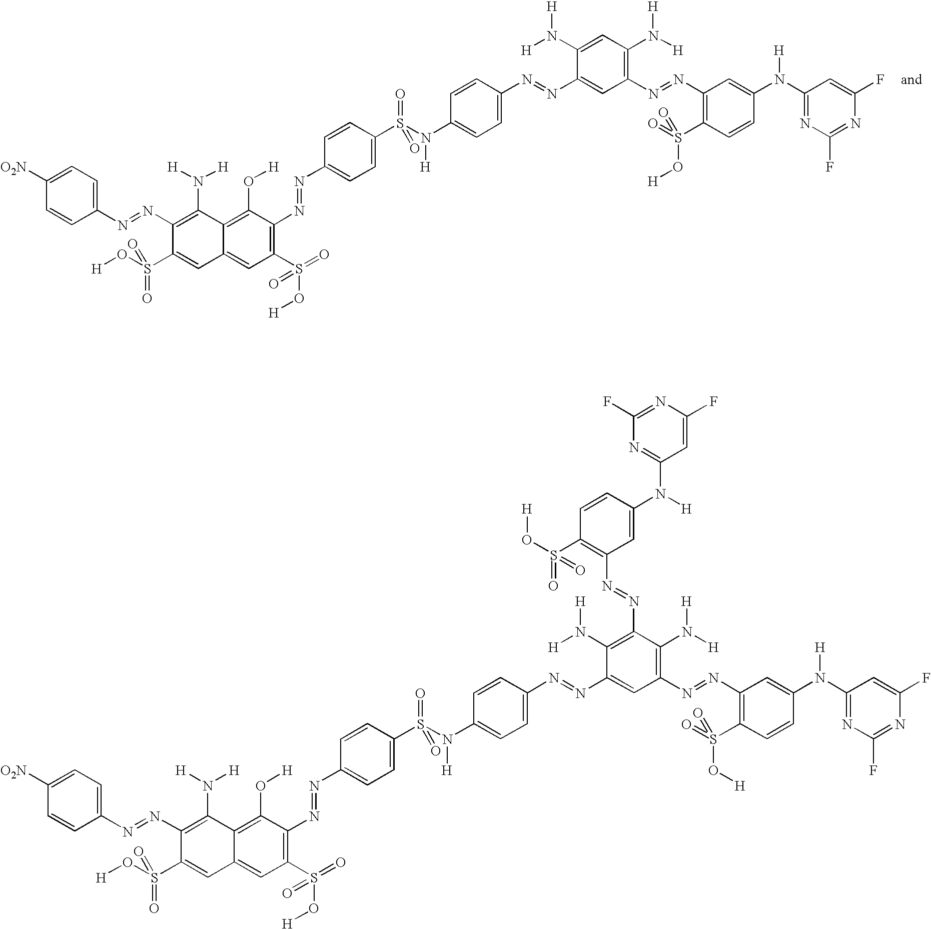
are present as components. The product is obtained as a dark powder which dyes wool and nylon in olive green shades and leather in black shades having good all-round fastnesses. The dye goes very well onto the substrate and has good detachment fastnesses, for example solvent fastnesses.

### EXAMPLE 4

The product obtained according to Example 1e is reacted, in the manner described in Example 2d, with a diazonium salt obtained from the compound of the formula 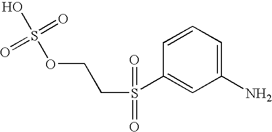
by the method described in Example 1a. The dye obtained is precipitated in a conventional manner by addition of sodium chloride. The suspension obtained is filtered off with suction and the filter cake is dried at 50° C. to leave a mixture which in the form of the free acid conforms to the formula 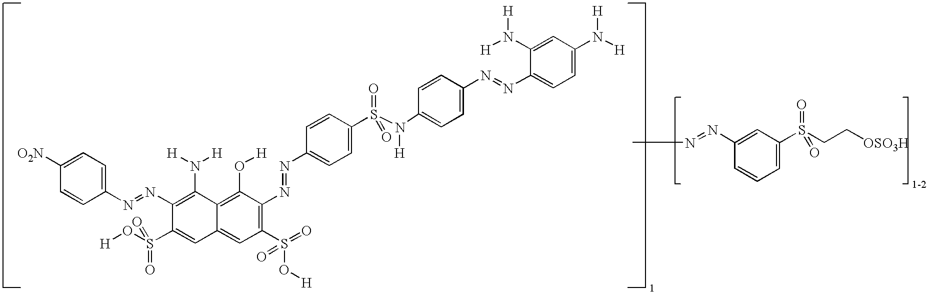
as a dark powder which dyes wool and nylon in olive green shades and cattle-hide side leather in black shades having good all-round fastnesses. The mixture comprises components which conform to the components indicated in Examples 1 to 3.

### EXAMPLE 5

The product obtained according to Example 1e is reacted, in the manner described in Example 2d, with a diazonium salt obtained from the compound of the formula 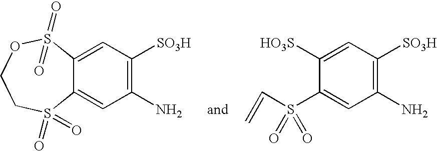
by the method described in Example 1a. The dye obtained is precipitated in a conventional manner by addition of sodium chloride. The suspension obtained is filtered off with suction and the filter cake is dried at 50° C. to leave a mixture which in the form of the free acids conforms to the formulae 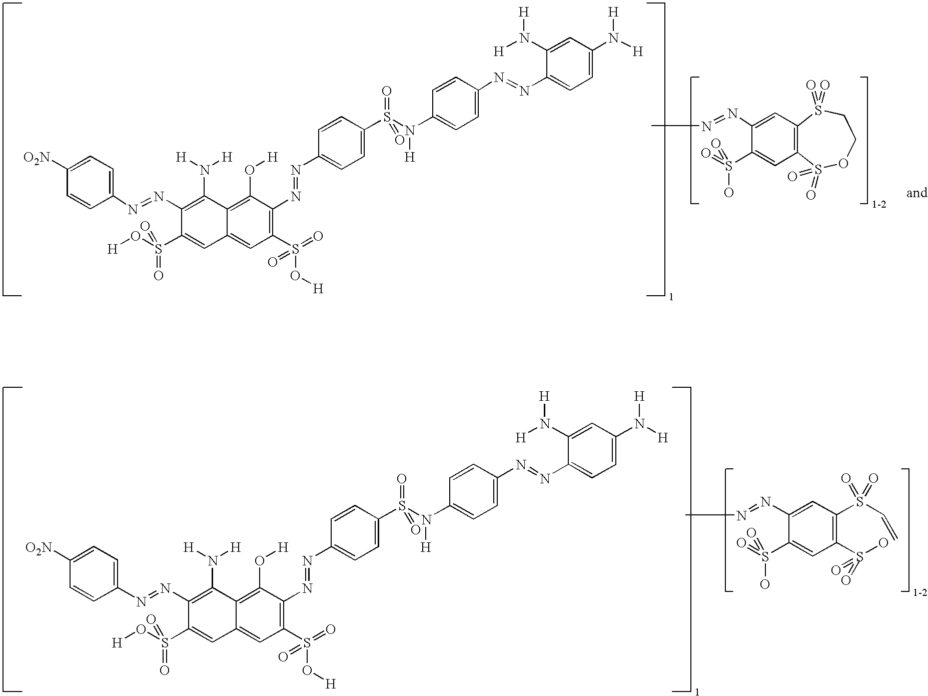
as a dark powder which dyes wool and nylon in green shades and cattle-hide side leather in black shades having good all-round fastnesses. The mixture comprises components which conform to the components indicated in Examples 1 to 3.

### EXAMPLE 6

The product obtained according to Example 1e is reacted, in the manner described in Example 2d, with a diazonium salt obtained from the compound of the formula 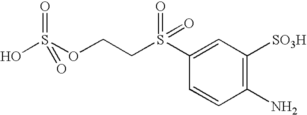
by the method described in Example 1a. The dye obtained is precipitated in a conventional manner by addition of sodium chloride. The suspension obtained is filtered off with suction and the filter cake is dried at 50° C. to leave a mixture which in the form of the free acid conforms to the formula 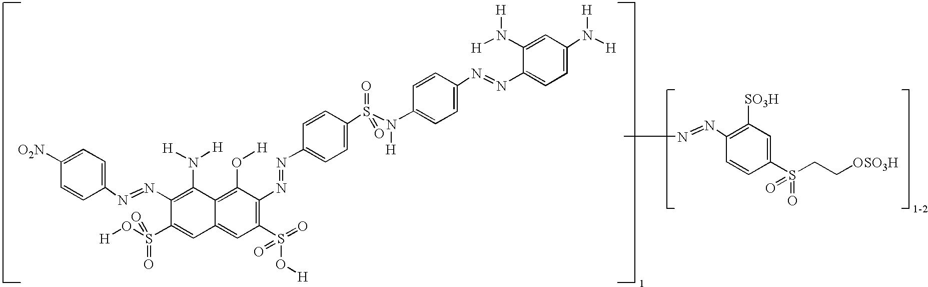
as a dark powder which dyes wool and nylon in olive green shades and cattle-hide side leather in black shades having good all-round fastnesses. The mixture comprises components which conform to the components indicated in Examples 1 to 3.

### EXAMPLE 7

Reacting the following starting compounds 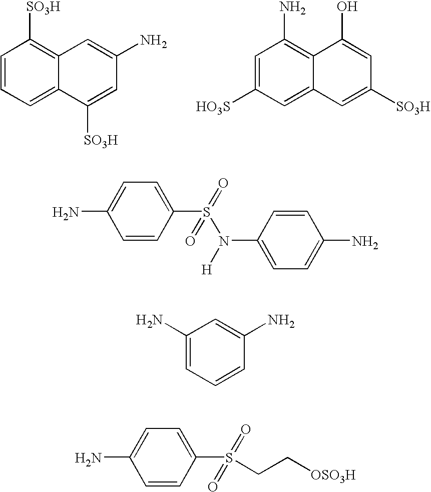
is in the manner described in the preceding examples gives the product of the formula 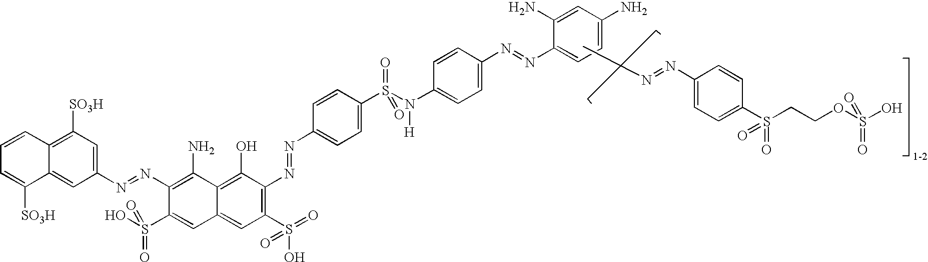
which dyes leather in bluish black shades.

### EXAMPLE 8

Reacting the following starting compounds 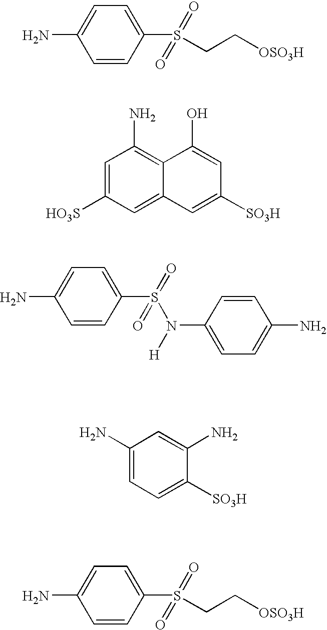
in the manner described in the preceding examples gives the product of the formula 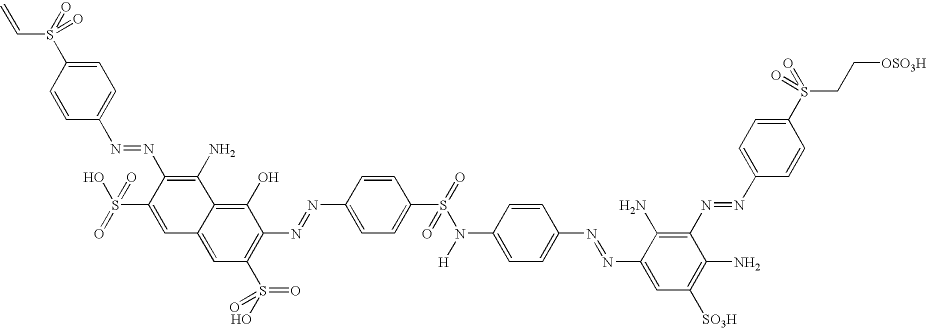
which dyes leather in green shades.

### EXAMPLE 9

Treating the product obtained according to Example 8 with aqueous sodium hydroxide solution by stirring a solution in water thereof at pH 10 to pH 11 at room temperature for two hours and then adjusting the pH to 7 with hydrochloric acid and evaporating the reaction mixture gives a product of the formula 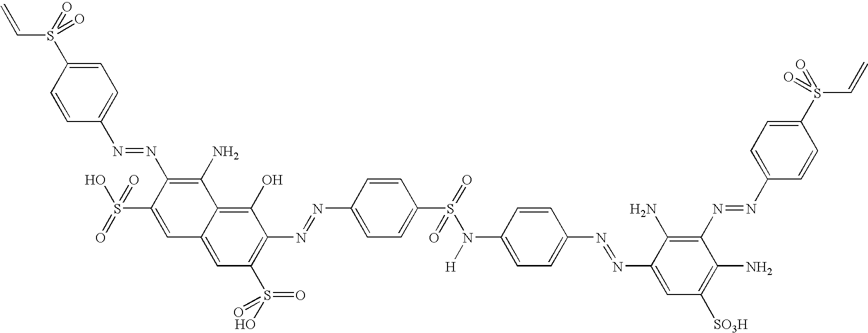
which likewise dyes leather in green shades.

### EXAMPLE 10

Reacting the following starting compounds 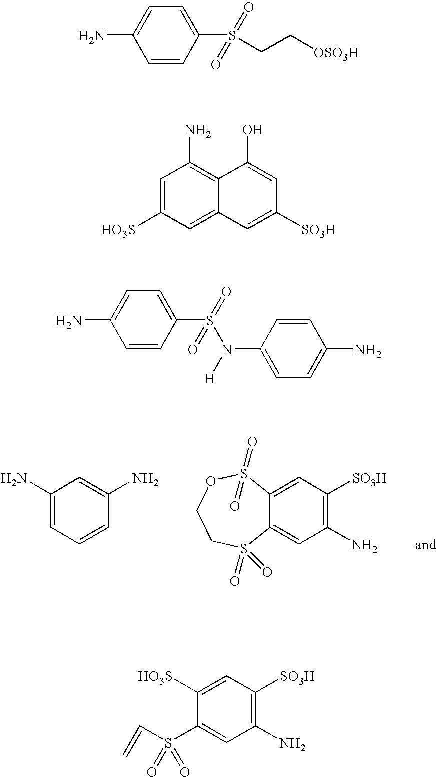
in the manner of the preceding examples gives a mixture which in the form of the free acid conforms to the formulae

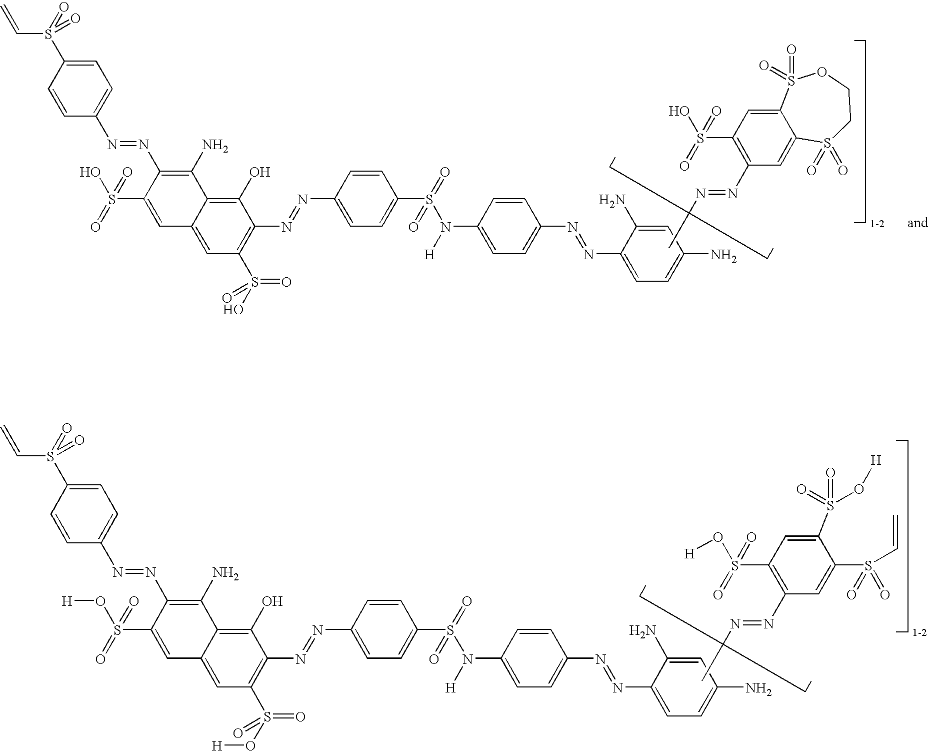

The product dyes leather in gray shades.

### EXAMPLE 11

Reacting the following starting compounds 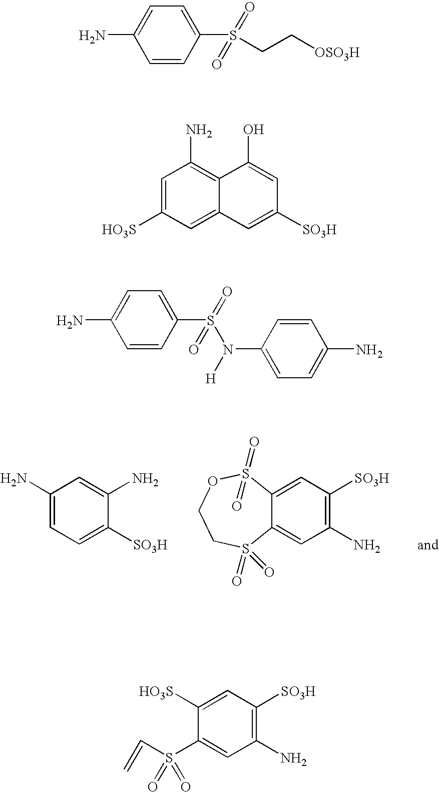
in the manner of the preceding examples gives a mixture which in the form of the free acid conforms to the formulae 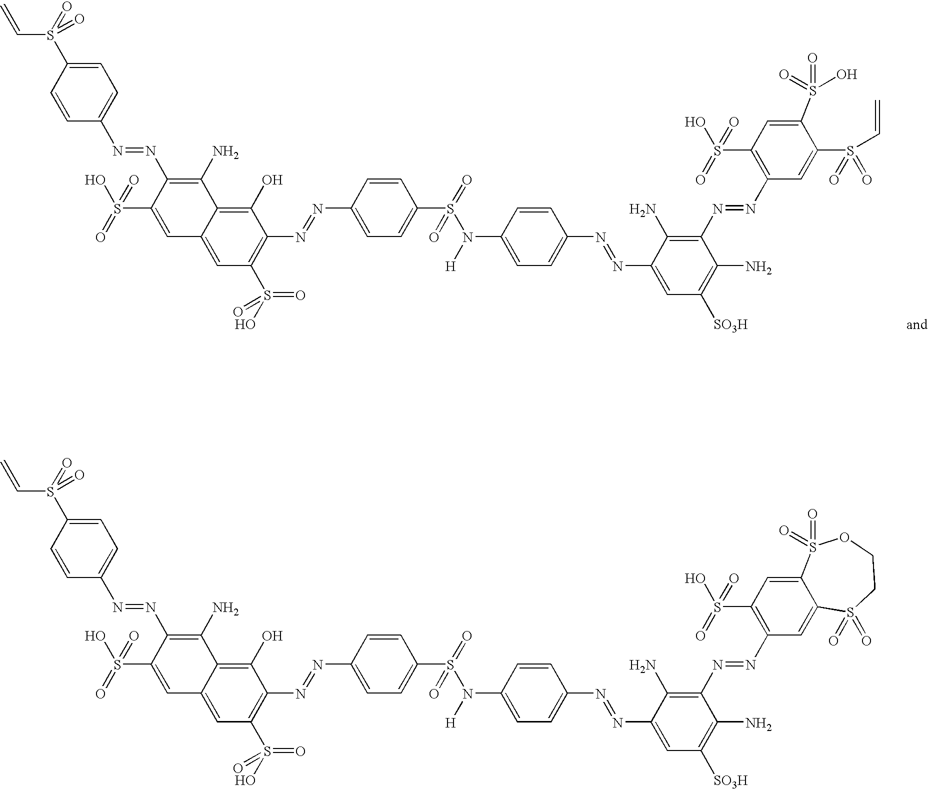
and dyes leather in gray shades.

Further polyazo dyes according to the present invention are obtained by reacting the starting compounds mentioned in the table which follows:

| Ex- | | | | | |
|---|---|---|---|---|---|
| am- | Compound of | Compound of | Compound of | Compound of | Compound of |
| ple | formula IV | formula VI | formula VII | formula VIII | formula V |
| 12 | 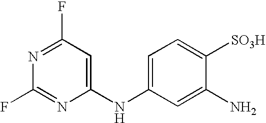 | 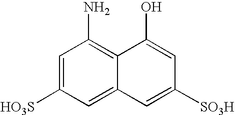 | 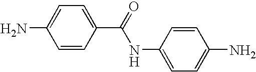 | 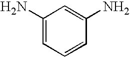 | 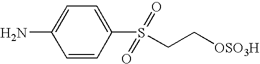 |
| 13 | 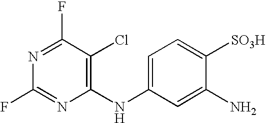 | ″ | ″ | ″ | ″ |
| 14 | | ″ | ″ | ″ | ″ |
| | 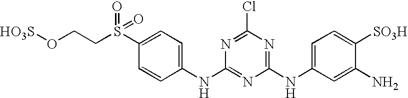 | | | | |
| 15 | | ″ | ″ | ″ | ″ |
| | 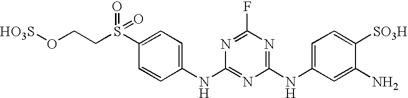 | | | | |
| 16 | 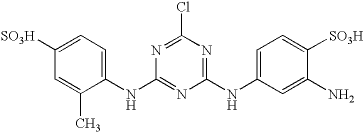 | 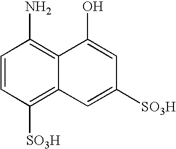 | ″ | 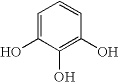 | 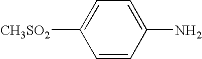 |
| 17 | 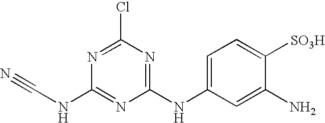 | ″ | 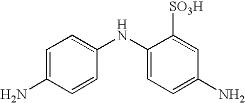 | 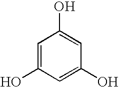 | 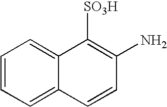 |
| 18 | 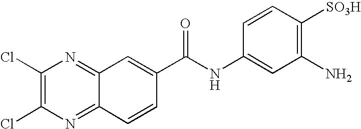 | 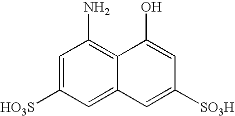 | 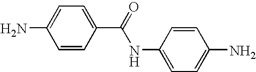 | 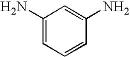 | 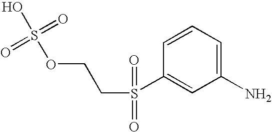 |
| 19 | 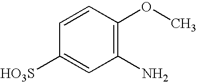 | ″ | 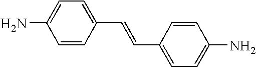 | ″ | 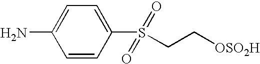 |
| 20 | 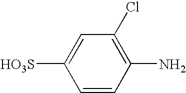 | ″ | ″ | 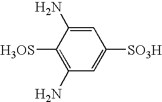 | ″ |
| 21 | 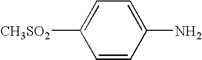 | 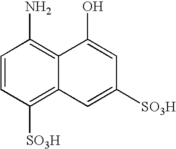 | 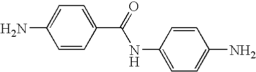 | 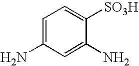 | 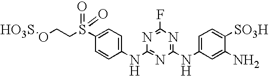 |
| 22 | 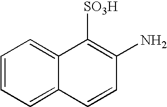 | 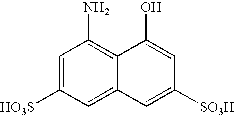 | ″ | 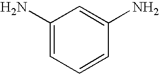 | ″ |
| 23 | 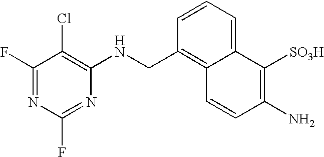 | ″ | ″ | ″ | 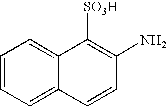 |
| 24 | ″ | ″ | 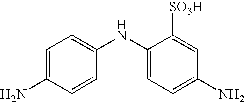 | 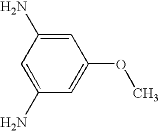 | 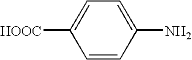 |
| 25 | 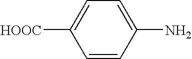 | ″ | 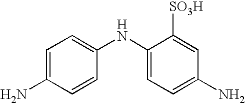 | 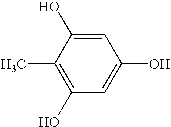 | 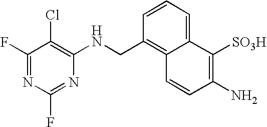 |
| 26 | 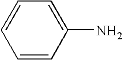 | ″ | 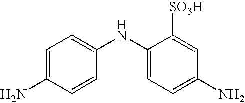 | 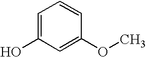 | 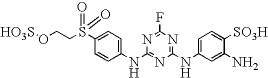 |
| 27 | 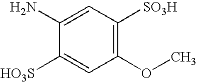 | ″ | 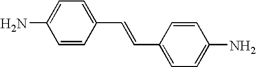 | 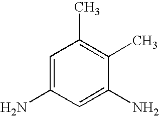 | 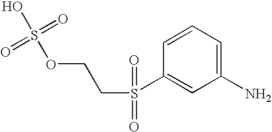 |
| 28 | 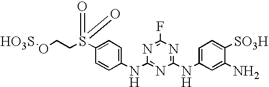 | ″ | 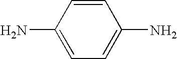 | 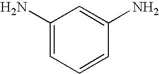 | 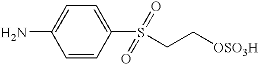 |
| 29 | 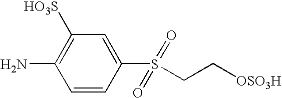 | ″ | 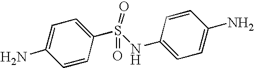 | ″ | ″ |
| 30 | ″ | ″ | ″ | ″ | 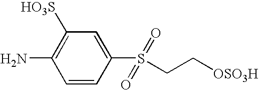 |
| 31 | 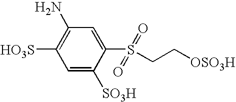 | ″ | ″ | ″ | 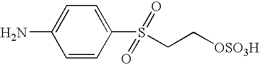 |
| 32 | ″ | ″ | ″ | ″ | 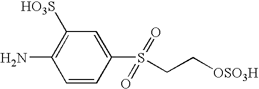 |
| 33 | ″ | ″ | ″ | ″ | 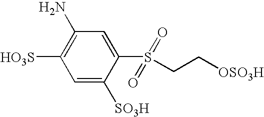 |
| 34 | 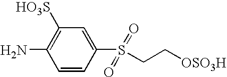 | ″ | ″ | ″ | ″ |

Dyeing example (method of dyeing cattle-hide side leather)

(Parts are by weight)

a) Preparing the leather:

90 parts of a conventionally tanned leather having a shaved thickness of 2.2 mm were admixed in 250 parts of water with 0.45 part of calcium formate and 0.225 part of sodium carbonate at a temperature of 60° C., so that a pH of 4 to 5 results. The leather is drummed for 60 minutes. The leather is subsequently washed in 500 parts of water.

This is followed by retanning in 250 parts of water at a temperature of 40° C. with 5 parts of a commercially available synthetic tanning agent. The leather is drummed in the retanning liquor for 45 minutes, removed and washed with water.

b) Dyeing the leather:

0.045 part of the dye according to any one of the preceding examples which is to be dyed is dissolved in 300 parts of water, 15 parts of leather are added and the liquor is adjusted to pH 4 with a buffer. As the leather is being drummed in the dyeing liquor, the liquor is heated to 80° C. over 20 minutes, maintained at 80° C. for 20 minutes, heated to 100° C. over a further 15 minutes and maintained at 100° C. for 45 minutes. This is followed by cooling down to 40° C. and removal of the leather from the dyebath. Thereafter, the leather is rinsed cold, set out, dried and staked.

1-10. (canceled)

11. A polyazo dye of the general formula I 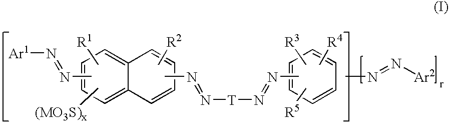
where
Ar¹ and Ar² are independently substituted or unsubstituted aryl subject to the proviso that at least Ar¹ or Ar² bears a fiber-reactive group;
T is a radical of the general formula II 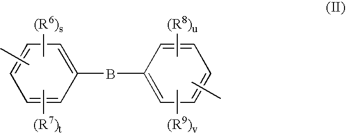
where B is a bridging element of the formula —NH—, —CO—, —SO₂—, —CH═CH—, —CH₂—CH₂—, —NH—CO—, —NH—SO₂—, —SO₂—NH—SO₂— or a direct bond;
R⁶, R⁷, R⁸ and R⁹ are independently hydrogen, —SO₃M, hydroxyl, amino, (C₁-C₁₂)-alkylamino with or without substitution in the alkyl group, di-(C₁-C₁₂)-alkylamino with or without substitution in the alkyl groups, substituted or unsubstituted (C₁-C₄)-alkyl, substituted or unsubstituted (C₁-C₄)-alkoxy, halogen or cyano; and
s, t, u and v are independently 0, 1 or 2;
or T is a radical of the general formula III 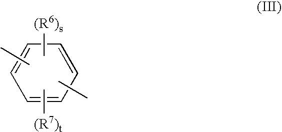
where R⁶, R⁷, s and t are each as defined above;
R¹ and R² are hydrogen, amino or hydroxyl subject to the proviso that the two radicals cannot both be amino or hydroxyl;
M is hydrogen, an alkali metal or the equivalent of an alkaline earth metal;
x is 0, 1 or 2;
R³ and R⁴ independently have one of the meanings of R⁵ or are
—COOM, —COOR¹⁰, —CONR¹¹R¹², —SO₂NR¹³R¹⁴ or —CO—R¹⁵;
and
R⁵ is hydrogen, OR¹⁶ or —NR¹⁷R¹⁸, where
R¹⁰, R¹¹, R¹², R¹³, R¹⁴, R¹⁵, R¹⁶, R¹⁷ and R¹⁸ are independently hydrogen, unsubstituted (C₁-C₄)-alkyl or (C₁-C₄)-alkyl substituted by hydroxyl, vinyl, phenyl, —CN or —COO(C₁-C₄)-alkyl; and
r is 1 or 2,
except polyazo dyes where r is 2, R⁵ and one of R³ and R⁴ are amino and the other of R³ and R⁴ is —COOM, —COOR¹⁰, —CONR¹¹R¹² or —CO—R¹⁵,
and also their mixtures with each or one another.

12. The polyazo dye according to claim 11, wherein the fiber-reactive groups on Ar¹ and Ar² are groups of the formulae —SO₂CH═CH₂ or —SO₂CH₂CH₂Z, where Z is an alkali-eliminable grouping; or
heterocyclic groups of the formulae 1, 2 and 3 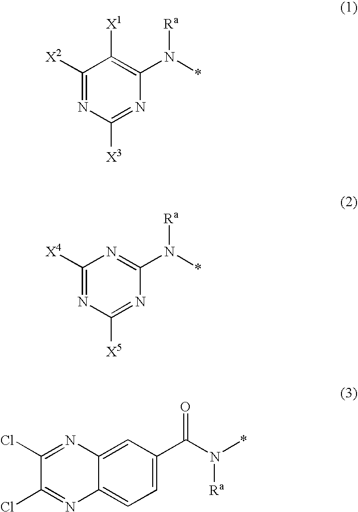
where
* indicates the bond to Ar¹ and Ar²;
R^{a} is hydrogen, phenyl or (C₁-C₄)-alkyl;
X¹ to X³ are independently hydrogen, cyano or halogen with the proviso that at least one of X₂ and X₃ be halogen,
X⁴ is chlorine or fluorine,
X⁵ is a group of the general formula —N(R^{b})—Y—R′,
where
R^{b} is hydrogen, phenyl or (C₁-C₄)-alkyl;
Y is (C₁-C₆)-alkylene with or without interruption by —O— or is a group of the formula 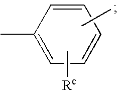
R^{c} is hydrogen, (C₁-C₄)-alkyl, (C₁-C₄)-alkoxy, sulfo or chlorine; and
R^{′} is —SO₂CH═CH₂ or —SO₂CH₂CH₂Z, where Z is as defined above; or
is a group of the general formula —N(R^{b})—R″,
where
R^{b} is as defined above; and
R″ is unsubstituted phenyl, phenyl substituted by one, two or three substituents selected from the group consisting of sulfo, (C₁-C₄)-alkyl and (C₁-C₄)-alkoxy, unsubstituted naphthyl, naphthyl substituted by one, two or three substituents selected from the group consisting of sulfo, (C₁-C₄)-alkyl and (C₁-C₄)-alkoxy, or cyano,
and R^{b} and R″ can also be combined to form a heterocyclic ring.

13. The polyazo dye according to claim 12, wherein R^{b} and R″ can also be combined to form a piperidino, piperazino or morpholino ring.

14. The polyazo dye according to claim 12, wherein the fiber-reactive groups on Ar¹ and Ar² are groups of the formulae —SO₂CH═CH₂, —SO₂CH₂CH₂OSO₃H, or 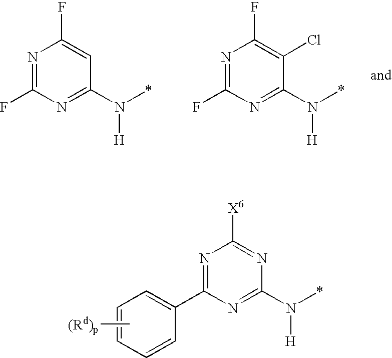
where
* indicates the bond to Ar¹ and Ar²;
X⁶ is fluorine or chlorine;
R^{d} is sulfo, sulfo, (C₁-C₄)-alkyl, (C₁-C₄)-alkoxy, —SO₂CH═CH₂ or
—SO₂CH₂CH₂OSO₃H; and
p is 0, 1, 2 or 3.

15. The polyazo dye according to claim 11, wherein T is a group of the general formula II.

16. The polyazo dye according to claim 11, which conform to the general formula Ia 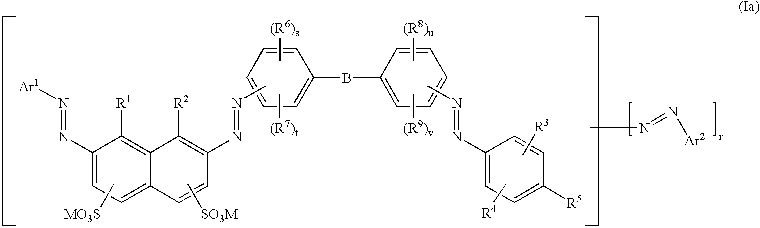
where Ar¹, Ar², R³, R⁴, R⁶, R⁷, R⁸, R⁹, M, r, s, t, u and v are each as defined in claim 1;
B is —NH—, —NH—CO— or —NH—SO₂—; and
one of R¹ and R² is hydroxyl and the other amino, and
R⁵ is OR¹⁶ or —NR¹⁷R¹⁸, where R¹⁶, R¹⁷ and R¹⁸ are as defined in claim 11.

17. The polyazo dye according to claim 11, which conform to the general formula Ib 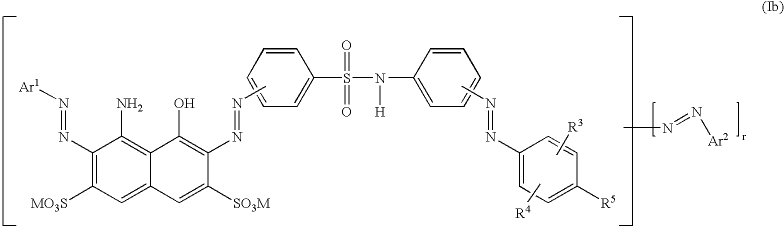
where Ar¹, Ar², R³, R⁴, M and r are each as defined in claim 11; and
R⁵ is OR¹⁶ or —NR¹⁷R¹⁸, where R¹⁶, R¹⁷ and R¹⁸ are each as defined in claim 11.

18. A process for preparing the polyazo dye according to claim 11, which comprises constructing it from compounds of the general formulae IV to VIII 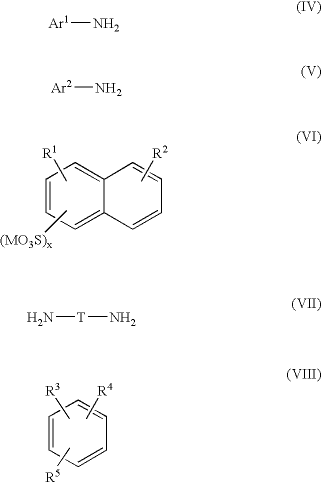
where Ar¹, Ar², R¹ to R⁵, T, M and x are each as defined in claim 11, in diazotization and coupling reactions in any order.

19. The process for dyeing or printing hydroxyl- and/or carboxamido-containing material which comprises contacting the polyazo dye according to claim 11 with said material.

20. The process according to claim 18 wherein leather is dyed.

21. The process according to claim 19 wherein the utilized solution of the polyazo dye has a pH of less than 7.
